(19) United States
(12) Patent Application Publication
(10) Pub. No.: US 2009/0182629 A1
(43) Pub. Date: Jul. 16, 2009

(54) Media Content Protection

(76) Inventor: Arnon Hadas, Raanana (IL)

Correspondence Address: YORAM TSIVION, P.O. BOX 1307, PARDES HANNA, 37111, IL

(21) Appl. No.: 11/720,328

(22) PCT Filed: Nov. 21, 2005
(86) PCT No.: PCT/IL05/01227

§ 371 Date: May 27, 2007

Related U.S. Application Data
(60) Provisional application No. 60/630,565, filed on Nov. 26, 2004.

(51) Int. Cl. G06Q 30/00

(52) U.S. Cl. 705/14; 726/26; 700/94

(57) ABSTRACT

Method and system for protection of digitally formed media from illegal use and distribution. The method comprises the steps of producing a random spatial and temporal mix of at least one embedded advertisement and at least one digital content track and producing a digital media product using the random mix. The digital content may exemplarily be music or digital video and the content may be a compact disk or digital video disk. Advantageously, due to the random mixing the method brings in advertisement revenue and prevents machine erasing of advertisements.

### FIELD AND BACKGROUND OF THE INVENTION

The present invention relates to media distribution business models, and in particular to distribution of recorded media with the aim of preventing revenue loss due to illegal copying and distribution of digital media such as contact discs (CDs) and digital video discs (DVDs).

The music industry is at present suffering from massive revenue loss due to illegal copying and distribution of pirated CDs and illegal downloads of music and tracks other digital media from the Internet. The total market share of illegal CDs is estimated at 50% of total music sales.

Various business models and techniques aimed at preventing illegal copying and distribution of recorded media are known. Some of these are disclosed in U.S. patent applications 20010049824 to Baker et al, 20040028226 to Saar et al, 20030068043 to Tam et al, US 20010056573 to Kovac et al, and U.S. 20040139161 to Loh, and in WO0116666 to Sneath et al., WO 0154420 to Sharp, WO 09709708 to Subramanian et al., WO03085633 to Khoo et al. and WO 2004054204 to Dempski. Some of these applications deal with advertisement distribution over mass media and incorporation of advertisements in recorded digital media. While providing some solutions to the problem of illegal copying and distribution of audio CDs or video DVDs, none of these prior art applications are entirely satisfactory in preventing revenue loss to the legal owners.

There is therefore a widely recognized need for, and it would be highly advantageous to have, an efficient solution to the problem of revenue loss due to media content piracy.

### SUMMARY OF THE INVENTION

The present invention is of a business model and technique that prevents revenue losses due to illegal copying and distribution of CDs and DVDs. The invention uses random embedding of commercial advertisements in CDs as means of raising revenue from advertisers. The random insertion is performed in a way that prevents “automated” or “mass” erasing by a machine. The user of an illegal CD or DVD is left with the choice of listening to or seeing the advertisement, or trying the tedious task of individually blocking and eliminating randomly positioned ads from his CD or DVD. Illegally copied and distributed CDs and DVDs thus become an advertising venue for the legal copyright owners, and the advertising stream becomes a source of income that compensates for the income lost due to the illegal copying and distribution.

According to the present invention there is provided a method for protection of digitally formed media from illegal use and distribution comprising the steps of: producing a random mix of at least one embedded advertisement and at least one digital content track and producing a digital media product using the random mix, whereby the random mix brings in advertisement revenue and prevents machine erasing of the at least one embedded advertisement.

According to one aspect of the invention, the step of producing a random mix includes producing a random mix of at least one embedded advertisement and at least one music track to form at least one new music track.

According to another aspect of the invention, the step of producing a random mix includes producing a random mix of at least one embedded advertisement and at least one digital video track to form at least one new digital video track.

According to yet another aspect of the invention, the at least one new music track includes a plurality of new music tracks, and the step of producing a digital media product includes producing at least one compact disk comprising the plurality of new music tracks.

According to yet another aspect of the invention, the at least one new digital video track includes a plurality of new digital video tracks, and the step of producing a digital media product includes producing at least one digital video disk comprising the plurality of new digital video tracks.

According to yet another aspect of the invention, the at least one compact disk includes a plurality of compact disks in which new music tracks of an identical song differ in length.

According to the present invention there is provided a digitally formed media product comprising a random mix of at least one digital content track and at least one advertisement.

According to one aspect of the invention, the random mix includes a random mix selected from the group consisting of a temporal mix, a spatial mix and a combination thereof.

According to another aspect of the invention, the random mix includes a random mix of a first plurality of digital content tracks and a second plurality of advertisements.

According to yet another aspect of the invention, the product includes a single track selected from the group consisting of a music track and a digital video track.

According to yet another aspect of the invention, the product is selected from the group consisting of a compact disc and a digital video disk.

### BRIEF DESCRIPTION OF THE DRAWINGS

The invention is herein described, by way of example only, with reference to the accompanying drawing, wherein:

FIG. 1 is a flow chart showing a preferred embodiment of the method for media content protection of the present invention.

FIG. 2 shows a specific example of random embedding of commercials in music tracks;

FIG. 3 shows schematically a system used to implement the method for media content protection of the present invention

### DESCRIPTION OF THE PREFERRED EMBODIMENTS

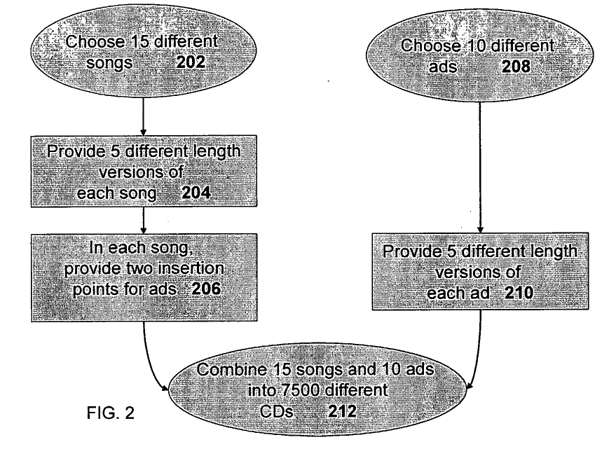

The present invention is of a method for media content protection that can be used to prevent revenue loss due to illegal copying of digital audio CDs and video DVDs. The prevention is accomplished by random embedding of advertisements (“ads”) into digital content tracks. By “random” we mean spatial and temporal randomness. This method thus enables to produce music CDs or video DVDs with randomly embedded advertisements in music (or video or image) tracks. We will henceforth describe the method and corresponding system with reference to CDs (music), while it is clear that it applies equally well to DVDs (video) as well as any other digital content formats. Each CD may be provided with a different embedded ad structure based on random location (e.g. at the beginning or end of a track) and duration of each track and/or ad. This means that each CD edition has a large number of different variations (actual individual CDs), see example in FIG. 2. As a result, erasure of the advertisements is possible only manually. The use of advertisements allows a reduction in the CD price, which reduces the incentive of potential customers to copy the CD or download music illegally.

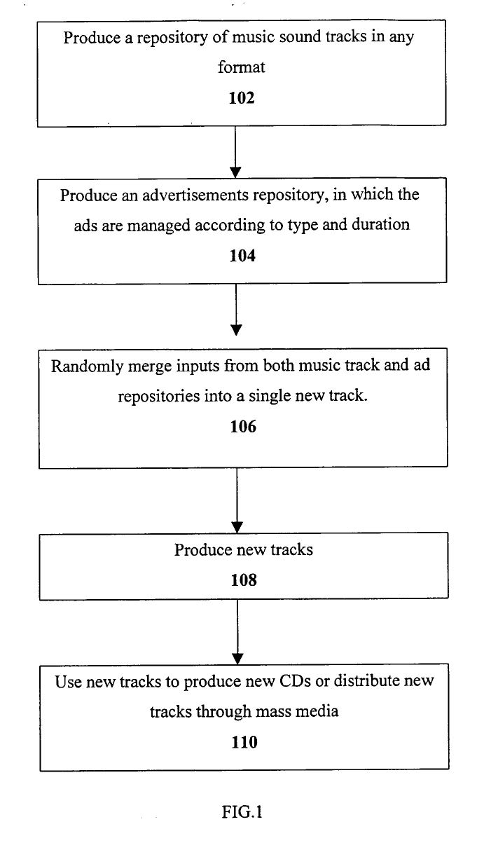

FIG. 1 shows a flow chart of the main steps of the method, following the production of a new CD. In step 102, the legal content owner (or simply “owner”) produces a repository of music sound tracks in any format such as MP3, WAV, etc. The music repository serves as a first input source of music tracks to the system. Each music track may include temporal variations of the same song, i.e. the same song may have different lengths. For example a song may have lengths of 4 min, 4 min. 1 sec, 4 min 2 sec. etc. Dynamic “temporal” manipulation of digital data in which many versions are produced of a given digital product with slightly different lengths is known in the art (printing for example). This manipulation is performed using well known dynamic manipulation algorithms and may be applied to digital music or video content as well. In step 104, the owner produces an advertisements repository, in which the ads are also managed dynamically (i.e. given similar dynamic manipulation as the songs). The ad repository serves as a second input source to the system. The owner then performs, in step 106, a random merging process of inputs from both a music track and ad repositories, merging them together into a single new track. Note that an ad may be added to the beginning or to the end of a song (or both). Thus the merging process results in both temporal and spatial variation. A new music track is then produced in step 108. This music track may have one ad attached at either end of a song, or two ads attached at both ends. Due to the variations in length of the song and the ads, a large number of combinations is possible for forming a single new track New CDs that comprise a plurality of these new tracks are produced in step 110. A new track may be distributed as a stand-alone media product (e.g. through the Internet and other distribution networks) or as mass produced product (here in the form of a CD). The invention is particularly useful for preventing loss of revenue due to illegal distribution of music and other digital media products downloaded from the Internet. Since the new track has a variable length, it cannot be edited or otherwise manipulated automatically (mechanically). Thus, if single new music tracks are copied and distributed illegally, they will most likely include ads that cannot be erased automatically. The ads will bring revenue to the content owners, overcoming any revenue loss due to the illegal copying and distribution of the content (music) itself. When output in new CDs, each CD may be different from other CDs that include the same tracks/ads as explained in more detail with reference to FIG. 2.

FIG. 2 shows a specific example of random embedding of ads in music tracks, illustrating the random merging of 15 different songs with 10 different ads. The temporal variation of single new tracks and the different permutations available in combining a particular song with one or two ads provide a very large amount of permutations of CDs with 15 new tracks. The ads cannot be removed automatically because the start and end points of a song are unknown a-priori (spatial variation). In the example of FIG. 2, 15 songs are chosen for a music repository in step 202, and each song is provided with 5 different lengths in step 204. The beginning and end of each song is made available for ad insertion in step 206. Five ads are chosen in step 208 for an ad repository and, as with the songs, each ad is similarly provided with 5 different lengths in step 210. The ads are merged randomly with the songs into new tracks in step 212. Assuming one ad is added to each song, the minimum number of different CD produced is 15×5×2×10×5=7500. Alternative permutations may include some new tracks having no ads at all, some tracks having two ads per song, etc.

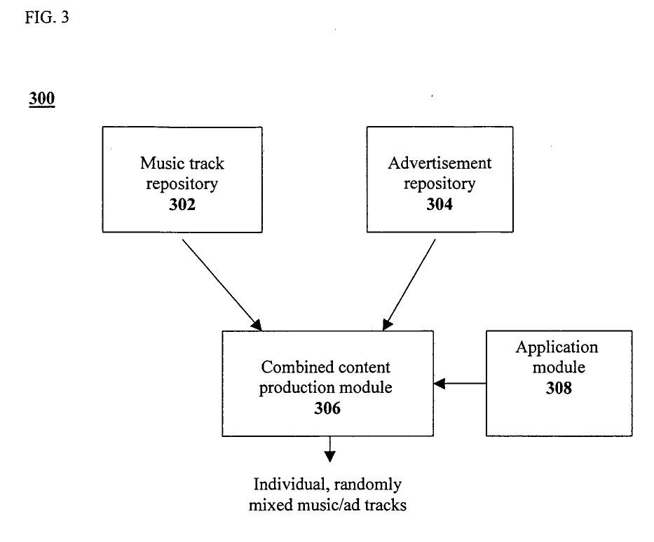

FIG. 3 shows schematically a system 300 used to implement the method for media content protection of the present invention. The system comprises a repository of digital content (e.g. music or video) tracks 302, a repository of advertisement tracks 304, a combined content (digital media product) production module 306 and an application module 308. In some embodiments, modules 306 and 308 may be combined into a single unit. Application module 308 is operative to perform the random mixing of content tracks and advertisements, and optionally their dynamic manipulation. Combined content module 306 is operative to produce the media product.

All patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for protection of digitally formed media from illegal use and distribution, comprising the steps of:
a. producing a random mix of at least one embedded advertisement and at least one digital content track; and
b. producing a digital media product using the random mix;
whereby the method brings in advertisement revenue and prevents machine erasing of the at least one embedded advertisement.

2. The method of claim 1, wherein the step of producing a random mix includes producing a random mix of at least one embedded advertisement and at least one music track to form at least one new music track.

3. The method of claim 1, wherein the step of producing a random mix includes producing a random mix of at least one embedded advertisement and at least one digital video track to form at least one new digital video track.

4. The method of claim 2, wherein the at least one new music track includes a plurality of new music tracks, and wherein the step of producing a digital media product includes producing at least one compact disk comprising the plurality of new music tracks.

5. The method of claim 3, wherein the at least one new digital video track includes a plurality of new digital video tracks, and wherein the step of producing a digital media product includes producing at least one digital video disk comprising the plurality of new digital video tracks.

6. The method of claim 4, wherein the at least one compact disk includes a plurality of compact disks in which new music tracks of an identical song differ in length.

7. The method of claim 1, wherein the step of producing a random mix includes producing a random temporal mix.

8. The method of claim 1, wherein the step of producing a random mix includes producing a random spatial mix.

9. The method of claim 1, wherein the digitally formed media is distributable through a mass distribution system such as an Internet.

10. A system for protection of digitally formed media from illegal use and distribution, comprising;
a. a digital content repository including a first plurality of digital content tracks;
b. an ad repository including a second plurality of ads;
c. an application module operative to randomly mix at least one digital content track and at least one ad into at least one new digital content track.

11. The system of claim 10, wherein the digital content includes music.

12. The system of claim 10, wherein the digital content includes digital video.

13. The system of claim 10, further comprising a combined content module operative to produce a digital media product that includes a third plurality of new digital content tracks in the form of a compact disk.

14. A digitally formed media product comprising a random mix of at least one digital content track and at least one advertisement.

15. The digitally formed media product of claim 14, wherein the random mix includes a random mix selected from the group consisting of a temporal mix, a spatial mix and a combination thereof.

16. The digitally formed media product of claim 14, wherein the random mix of at least one digital content track and at least one advertisement includes a random mix of a first plurality of digital content tracks and a second plurality of advertisements.

17. The digitally formed media product of claim 14, wherein the product includes a single track selected from the group consisting of a music track and a digital video track.

18. The digitally formed media product of claim 16, wherein the product is selected from the group consisting of a compact disc and a digital video disk.

19. The digitally formed media product of claim 14, distributable through and downloadable from a mass distribution system such as an Internet.
